(19) United States
(12) Patent Application Publication
(10) Pub. No.: US 2014/0179147 A1
(43) Pub. Date: Jun. 26, 2014

(54) PLUG

(71) Applicants: HONG FU JIN PRECISION INDUSTRY (ShenZhen) CO., LTD., (US); HON HAI PRECISION INDUSTRY CO., LTD., New Taipei (TW)

(72) Inventors: BO TIAN, Shenzhen (CN); YU HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/864,259

(22) Filed: Apr. 17, 2013

(30) Foreign Application Priority Data
Dec. 21, 2012 (CN) 201210560850.8

(51) Int. Cl. H01R 13/629

(52) U.S. Cl. CPC H01R 13/629
USPC 439/358

(57) ABSTRACT

A plug includes a main body, a number of pins, and a latch attached to a side of the main body. The pins extend down from the main body. The latch includes a connection portion extending from the main body, a hook extending down from the connection portion, a resilient arm extending up from the connection portion and connected to a top of the hook, and a handle extending up from the resilient arm and beyond a top of the main body. A second handle extends up from the main body, opposite to the latch.

### BACKGROUND

1. Technical Field

The present disclosure relates to a plug.

2. Description of Related Art

In a server, advanced technology extended (ATX) 20-pin plugs or ATX 24-pin plugs are used to connect sockets of a motherboard. When the plugs are unplugged from the sockets, the plugs are pulled up by fingers of an operator applying force on the plug and latches of the plugs need to be manipulated to disengage from housings of the sockets, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a plug, together with a socket.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

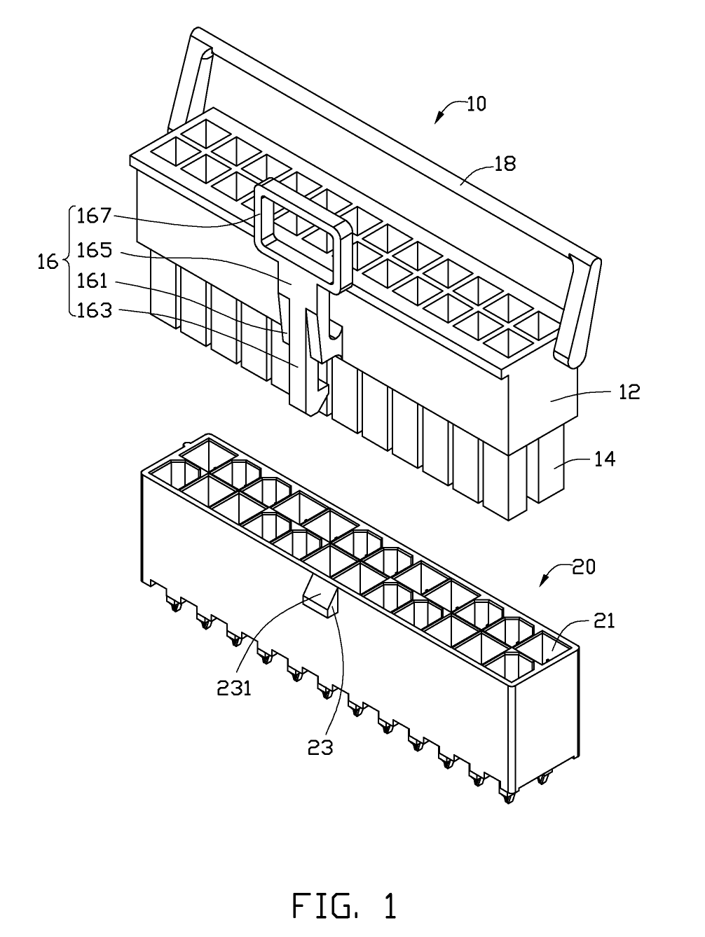

FIG. 1 shows an exemplary embodiment of a plug 10. The plug 10 is provided to be plugged in a socket 20.

The plug 10 includes a main body 12, a plurality of pins 14 extending down from the main body 12, and a resilient latch 16. The latch 16 includes a connection portion 161 extending from a side of the main body 12, a hook 163 extending down from the connection portion 161 and facing the pins 14, a resilient arm 165 extending up from the connection portion 161 and connected to a top of the hook 163, and an annular first handle 167 extending up from the resilient arm 165 and beyond a top of the main body 12. A U-shaped second handle 18 extends up from a top of the main body 12, opposite to the latch 16. Opposite ends of the second handle 18 are connected to opposite ends of the main body 12.

A plurality of slots 21 is defined in a top surface of the socket 20. A block 23 extends from a side of the socket 20. A slanting surface 231 is formed on a top of the block 23.

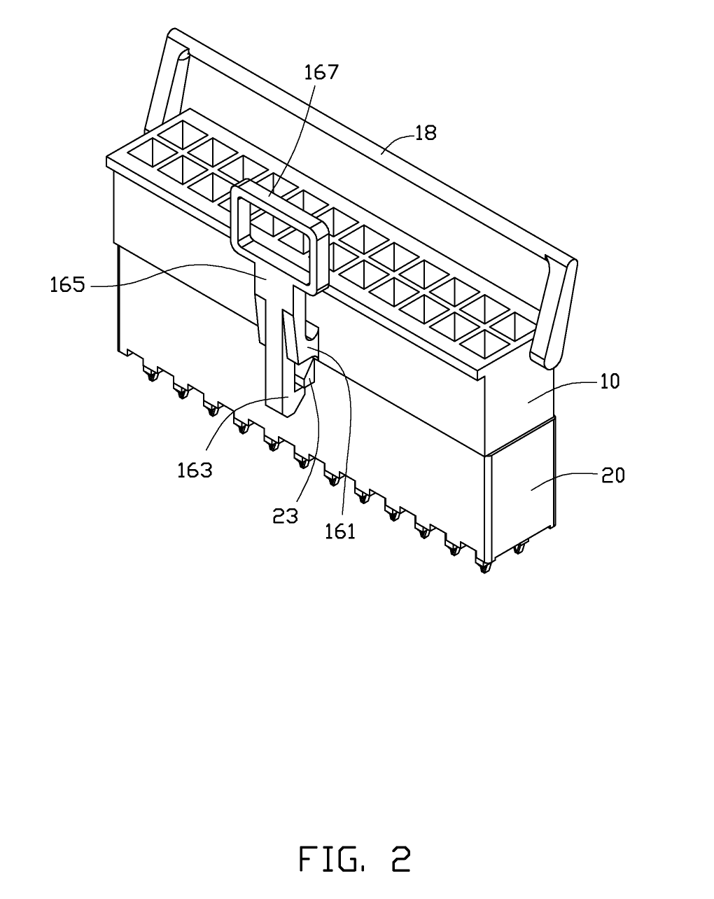

FIG. 2 shows in assembly. The plug 10 is manipulated down toward the socket 20. The pins 14 engage in the slots 21. The hook 163 slidably abuts against the slanting surface 231 and deforms outward. When the hook 163 passes by the block 23, the hook 163 is restored to engage with a bottom of the block 23. Thereby, the plug 10 is fastened to the socket 20.

To unplug the plug 10 from the socket 20, the first handle 167 is pulled toward the second handle 18. The resilient arm 165 deforms toward the second handle 18. The hook 163 moves away from the second handle 18 to disengage from the block 23. The second handle 18 is pulled up, allowing the plug 10 to be unplugged from the socket 20.

The plug 10 includes the first handle 167 and the second handle 18. An operator can operate the first handle 167 and the second handle 18 to unplug the plug 10 from the socket 20, which is convenient.

In the embodiment, the plug 10 is an advanced technology extended (ATX) 24-pin plug. In a second embodiment, the plug 10 is an ATX 20-pin plug.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A plug, comprising:
a main body;
a plurality of pins extending down from the main body; and
a latch attached to a side of the main body, the latch comprising a connection portion extending from the main body, a hook extending down from the connection portion, a resilient arm extending up from the connection portion and connected to a top of the hook, and a first handle extending up from the resilient arm and beyond a top of the main body; and
a second handle extending up from the main body, opposite to the latch;
wherein when the plug is plugged in a socket, the first handle and second handle is operable to unplug the plug from the socket.

2. The plug of claim 1, wherein the first handle is annular.

3. The plug of claim 1, wherein the second handle is U-shaped.

4. The plug of claim 3, wherein opposite ends of the second handle are connected to opposite ends of the main body.

5. The plug of claim 1, wherein the plug is an advanced technology extended (ATX) 24-pin plug.

6. The plug of claim 1, wherein the plug is an ATX 20-pin plug.
